(19) United States
(12) Patent Application Publication
(10) Pub. No.: US 2023/0377058 A1
(43) Pub. Date: Nov. 23, 2023

(54) MUSICIANS WORLD

(71) Applicant: Craig Short, Delaware, DE (US)

(72) Inventor: Craig Short, Delaware, DE (US)

(21) Appl. No.: 18/094,370

(22) Filed: Jan. 8, 2023

Related U.S. Application Data
(60) Provisional application No. 63/344,810, filed on May 23, 2022.

(51) Int. Cl. G06Q 50/00; G06F 16/9035

(52) U.S. Cl. CPC G06Q 50/01; G06F 16/9035

(57) ABSTRACT

A system for connecting musicians with one another on a communications network includes accessing a musician social network application by a first user through the communications network; providing first musician profile information and/or first musician preference information to the social network application by the first user; processing, by the musician social network application, the first musician profile information and/or the first musician preference information to determine a potential match with a second user, based on second musician preference information and/or second musician profile information about the second user; and transmitting the second musician preference information and/or the second musician profile information to the first user.

### CROSS-REFERENCE TO RELATED APPLICATIONS

This application claims the benefit of priority of provisional application U.S. Ser. No. 63/344,810 filed on May 23, 2022, which is incorporated by reference herein.

### BACKGROUND

### Technical Field

The present invention relates, in general, to apps, and, more particularly, and without limitation to an musician social network application directed to connecting musicians across a network.

The spread of digitalized music is becoming a popular trend. People are beginning to be accustomed to obtaining various abundant music contents from websites.

Music is often classified by genres, such as pop/rock, classical, folk, blues, country, and the like. Also, different versions of the same song are often recorded by different artists, and even the same artist may record variations of their own songs over the span of their career, such as, for example by performing a solo as a duet and performing an instrumentally accompanied song a cappella. While some music genres, such as pop/rock, have fewer different versions of the same song other genres lend themselves to having multiple versions. For example, genres that include predominantly older works, such as classic rock, “oldies” music, folk music, and classical music, often have identical portions of a work recorded by many different artists. For example, three different orchestras each conducted by a different conductor can each have its performance of Beethoven's Sixth Symphony recorded, resulting in three inherently unique versions of that symphony. However, because each performance is unique, a simple search for Beethoven's Sixth Symphony, either in a music store or in an online Internet library, will list three separate entries.

Unfortunately, without knowing anything more than the title of the work, a person cannot easily ascertain the differences between the three recording without listening to all three songs individually, which may not be convenient for a shopper who must either sample a small portion of the recording or purchase the entire recording prior to listening. In the case of sampling a portion of the recordings, the small sampling of each work may be insufficient to discern the differences and may not sample the portion of the music that the listener is particularly interested in isolating.

Still further, a musician desiring to find accompaniment, must spend a great deal of time searching the Internet for like-minded musicians, like music, like experience, and like performance format. Often, these searches must be performed individually, and a match in one category does not match other categories and even may be counter to what is desired in other categories.

Today there is an abundance of music, musicians, groups and performance styles. Indeed, there are so many digital music files alone available to a listener today (many millions of files), that it is impossible for any one person to be familiar with all of the choices. This problem is exacerbated when it is combined with the myriad of groups, musicians and styles. In dealing with such a vast collection of data, it is necessary to have many tools in order to assist users in finding what they want. For example, some prior art systems for searching music have been based on text and metadata (such as but not limited to artist names, track names, albums, years, genres, music review text, etc.). These systems fall short in even this limited application in that they can only index media that have been described by these meta-tags, and thus are a labor-intensive process when required for a large library of media files. Additionally, the metadata does not fully characterize the sound of the music, and so the searches fall short in many respects when a user is looking for a particular “sound” or “feel” of the music in any but the coarsest of senses (i.e., a particular artist or genre can be found, but one has difficulty, for example, finding music that contains sounds similar to the guitar solo in a particular recording that the user has on his computer). Thus, the prior art falls short in even limited applications.

Still further, there are many situations where it is useful to identify a media object or objects, e.g., songs, movies, plays, books etc., that are similar to another media object. Before electronic commerce, such determinations were made by people who had broad knowledge of the media available at the time. For example, the owner of a music or video store might recommend a particular item to a customer based on the owner's knowledge of the customer's tastes and the catalog of media. The value of the recommendation to the customer, however, was dependent on the owner's ability to accurately assess the customer's tastes as well as the owner's depth of knowledge of the available media. Adding further factors such as musician personal preferences, music styles, experience factors and the like will exponentially complicate this task.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A method, apparatus and user interface for connecting musicians with one another on a communications network includes accessing a musician social network application by a first user through the communications network; providing first musician profile information and/or first musician preference information to the social network application by the first user; processing, by the musician social network application, the first musician profile information and/or the first musician preference information to determine a potential match with a second user, based on second musician preference information and/or second musician profile information about the second user; and transmitting the second musician preference information and/or the second musician profile information to the first user.

The musician preference information may include musical genre, musical style, past musical performance, location of the user, musical instrument preference and preferred scheduling.

Other systems, methods, features and advantages of the invention will be, or will become, apparent to one with skill in the art upon examination of the following FIGS. and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a view of a communications network to allow musicians to search and connect with other musicians on a musician social network application, according to an aspect of the disclosure.

FIG. 2 is a view of a user interface that allows musicians to connect with other musicians on a musician social network application, according to an aspect of the disclosure.

FIG. 3 is a flowchart illustrating acts to allow musicians to search and connect with other musicians on a musician social network application, according to an aspect of the disclosure.

### DETAILED DESCRIPTION

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

The present disclosure provides a method, apparatus and graphical user interface for musicians to connect with other musicians across a network on a musician social network application, similar to a dating app in which the musician enters data about himself/herself and details of his/her performance, then enters details of the sort of accompaniment he/she is looking for.

The present disclosure allows a musician to visit a one-stop place to post/search/find other musicians without having to search many different web sites/classifieds presently available. A musician will have access to the entire world of musicians.

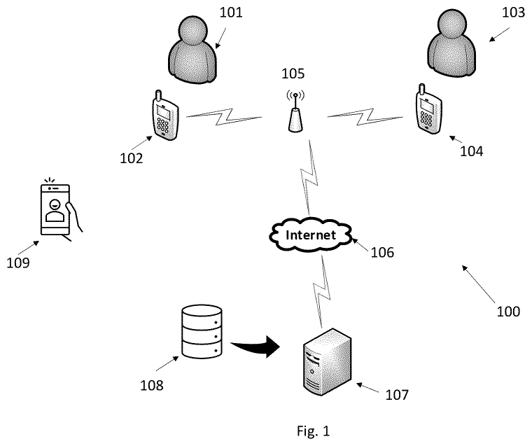

FIG. 1 illustrates an example communications network 100 employed by users (101, 103) to connect with other musicians on a musician social network application. In an aspect of the disclosure, the users (101, 103) may be musicians seeking to connect with other musicians for instruction or accompaniment or performing together. The musicians may be seeking other musicians of similar or desired musical genre, musical style, past musical performance, location of the user, musical instrument preference and preferred scheduling. The musicians may

The communications network 100 may include a first user equipment (UE) 102 and a second UE 104. There may be multiple UEs connected to the communications network 100 and the UEs may be smart phones, laptops, tablet devices, smart watches, desktop computers, or other equipment that can connect in a wired or wireless manner. The communications network 100 may include a wired or wireless access point (AP) 105. The AP 105 may be a terrestrial wireless network such as a cellular communications network, WiFi network or other wireless connectivity systems. The AP 105 may be a satellite that supports ground-based communications. Examples of a wired communications network includes Ethernet, fiber, cable or other wired communications connectivity systems.

In an aspect of the disclosure, the AP 105 may connect to the Internet 106, as understood by one of skill in the art. The Internet 106 may include various routers and hubs (not shown).

In an embodiment of the disclosed invention, the Internet 106 may connect UEs (102, 104) to a server 107. The server 107 may contain processors, input units, memory, and output display units (not shown). The server 107 may support the functions of the disclosed invention. The server 107 may be multiple servers and the method of the disclosed invention may be implemented across multiple servers, the UEs (102, 104) or other processing devices as needed. The server 107 may also include a cloud-based collection of one or more servers distributed in different locations and/or or making use of cloud-based applications to implement the disclosure.

In an embodiment, the server 107 may be located in local proximity to the UEs (102, 104) such that the UEs (102, 104) do not access the Internet 106 to make use of the disclosed invention.

In an aspect of the disclosure, the server 107 may interface with a database 108. The database 108 may store musician preference information, such as musical genre, musical style, past musical performance, location of the user, musical instrument preference and preferred scheduling of the first user or second user. The database 108 may be a distributed database, such that the database 108 may be referenced and/or accessed as more than one database 108 located proximate or connected to the server 107 or distributed across a network such the Internet 106 or other communications network, such as an intranet, mesh network, personal area network such as a Bluetooth network or a wide area network.

When users (101, 103) connect, an application interface 109 may be displayed on a UE (102, 104) with an application or website presented for a user (101, 103) to interact with to connect with other musicians.

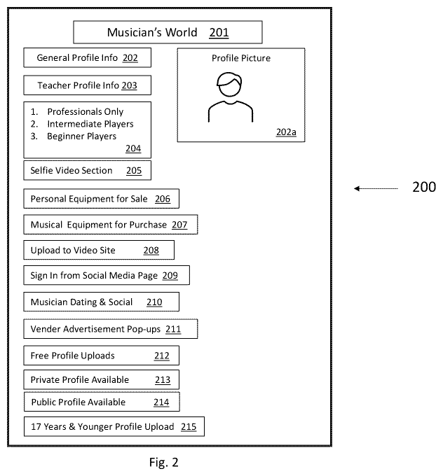

FIG. 2 is an example view of a graphical user interface (GUI) 200 for connecting musicians with each other for professional and social interaction on a musician social network application. The GUI 200 may be implemented on a website on the Internet 106. In an aspect, the GUI 200 may be implemented on a mobile device on an app, such as an app on a smartphone, smartwatch, tablet, wearable device or other mobile devices known to one of skill in the art.

The GUI 200 of the musician social network application provides a plurality of user interface regions for a musician to upload information, photos, videos, text and other types of files, media, hyperlinks or other documents and/or information to allow a first musician to connect with one or more other musicians of similar interests, styles, background, training and desires to connect with other musicians for professional work or social/dating contexts.

The GUI 200 may include a title splash page region 201, describing the name of the application. In an aspect, the splash page region 201 is entitled “Musician's World” Other titles or application descriptions may be used as well. The GUI 200 may provide a plurality of musician profile interface regions, including a general profile information interface region 202, a profile picture interface region 202a and a teacher profile information interface region 203 to allow a user to enter personal and professional information. Examples of the personal and professional information may include name, age, region, musical skills, styles, musical training and background, hobbies, interests, past projects/works, upcoming future projects/works, links to past performances, musical group affiliation or membership and other personal and professional information that the user might desire to enter into the general profile information interface region 202.

In an aspect the profile photo interface region 202a may allow a user to upload, edit and/or display a personal photo or icon image describing the user. In an aspect, the teacher profile information interface region 203 may allow a user who is also a music teacher to provide personal and professional information related to teaching services. A music teacher may describe education, experience, training, styles, genres, region of availability or online availability, links to works/projects/teaching engagements, links to job sites to advertise teaching availability to connect a music teacher with a musician, level of skill training the teacher can provide, rates for teaching services, recommendations and other professional and personal information a music teacher may want to enter and display in the teacher profile information interface region 203.

In an aspect of the disclosure, the GUI 200 may provide a skill level interface region 204 to allow users and musicians for different skill levels to interact with other musicians of similar skill levels. The skill level interface region 204 may provide links and input/output functionality for professionals only, intermediate players only and/or beginner players. The different skill levels may require a certification or verification of the skill level, to limit access to the different levels to users of a certain skill level. The skill level interface region 204, when a user interacts with the region, may provide links to components of the application for musicians of the specified skill level to connect, communicate, share/post links to musical performances, styles, genres, upcoming events, recommendations, tips/hints, video links, audio links, comments and postings and other information of interest to musicians wishing to connect with other musicians of a similar level. In an aspect, a beginner player section of the skill level interface region 204 may provide links to teachers or instructors or tips and suggestions on finding a teacher or instruction online or through books or other media.

The GUI 200 may provide a selfie video section interface region 205. Interacting with the selfie video section interface region 205, users may post short video clips of themselves playing music, performing at events, demonstrating musical instruments, talents and styles of the user. Other video clips may be possible, depending on the interest and preferences of the user.

The GUI 200 may provide a plurality of market exchange interface regions for musicians to engage in sales and/or purchase of musical equipment. A personal equipment for sale interface region 206 allows musicians or other users to sell personal musical equipment to other musicians or users. The personal equipment for sale interface region 206 may allow users to post text, links, video, audio samples, photos or other information for other users to evaluate for the sale of the personal equipment. Comments and message boards may also be provided to allow a user to interact with other interested in purchasing the user's personal equipment. Information about price, condition of equipment, region of sale and other types of information about the personal equipment may be entered and accessed through the personal equipment for sale interface region 206. A musical equipment for purchase interface region 207 may allow commercial entities to list musical equipment for purchase, including text, links, video, photos or other information for other users to evaluate for purchase of musical equipment.

The GUI 200 may include an upload to video site interface region 208. The upload to video site interface region 208 may allow a user to upload video clips to video sites such as YouTube, TikTok or other video sites for others to view, comment on, discuss and share.

The GUI 200 may include a sign-in from social media page interface region 209. The sign-in from social media page interface region 209 may allow a user to sign into the application from a social media site with pre-existing credentials to directly enter the application without a separate login and sign-in process. Examples of social media sites include Facebook, Instagram, Pinterest, Google, TikTok, Reddit and other social media networks and sites that may be used by a musician accessing the application. The sign-in from social media page interface region 209 may provide certification or verification through one-time passwords, authentication codes, two-factor authentication methods or other secure methods to verify the user's identity.

The GUI 200 may include a plurality of musical social network interaction interface regions, including, for example, a musician dating & social interface region 210, a vendor advertisement page interface region 211, a free profile uploads interface region 212 and a private profile available interface region 213. The musician dating & social interface region 210 may provide an interface for musicians to meet other musicians for social interaction, dating, social activity participation or other relationship types that musicians may seek other musicians for. The musician dating & social interface region 210 may provide secure, authenticated connections between users to allow a safe environment for musicians to meet other like musicians for dating or social interaction. The musician dating & social interface region 210 may provide a social/dating profile to be filled out, similar to or in addition to the general profile information entered with the general profile information interface region. The musician dating & social interface region 210 may provide an authentication or verification method to ensure identities of the users who wish to use the social/dating functionality. The musician dating & social interface region 210 may allow use of an algorithm to match musicians with each other based on information entered in the profile, or allow users to search for like musicians for social/dating interactions.

The GUI 200 may provide a vendor advertisement pop-ups page interface region 211. The vendor advertisement page interface region 211 may allow display of vendor pop-up ads targeted to specific users or general classes of users based on profile information entered into the app, location of users of the app or other targeted advertising techniques. A vendor may create and upload advertisements using the vendor advertisement page interface region 211. A user may view, select, block or filter pop-up advertisements selectively or generally using the vendor advertisement page interface region 211. The vendor advertisement page interface region 211 may use an algorithm or matching procedure to target users with advertisements or provide links to advertisements to display as pop-ups. A user may employ the vendor advertisement page interface region 211 to select, search for, respond to or filter types of advertisement content, or opt-in to certain types of pop-up advertisements, possibly from use of cookies or privacy policy selections.

The GUI 200 may provide a free profile uploads interface region 212. The free profile uploads interface region 212 may allow a user to upload a profile without a fee or subscription, which may allow basic access to the application but restrict features set up as paid or subscription base. The free profile uploads interface region 212 may allow a user to test-drive or sample the application and decide if the user wants to pay or subscribe to the application service for additional features not available through the free profile uploads interface region 212. Musicians may use the free profile uploads interface region 212 to get an understanding of the range of other musicians using the application.

The GUI 200 may also provide a private profile available interface region 213 and a public profile available interface region 214. The private profile available interface region 213 may be used by a musician to access private profiles connected with the application. The private profiles may be created through the application for users who do not want general access by users on the application to see their information, certain aspects of their information or be contacted by any or all or a subset of users on the application. For example, a famous musician with a profile on the application may not want to be contacted by general users, so that musician may want to create a private profile, either through the general profile information interface region 202, the private profile available interface region 213 or other profile services provided by the application. In contrast, the public profile available interface region 214 may allow users to access a public profile of a user/musician on the application. The public profile available interface region 214 may allow a user to view, contact, share with or otherwise interact with other users on the site. The public profile available interface region 214 may allow a user to interact with the application to determine a desired set of information about the owner of the public profile, set access restrictions to certain sets of information about the owner of the public profile and allow the user to designate the profile as public, though possibly with certain features restricted from view or interaction with a general user. For example, in an aspect, the owner of a public profile may make the profile information visible but disable communication or chat functions with general users. As a result, the plurality of musical social network interaction interface regions provide access restrictions related to one or more of the plurality of musical social network interaction interface regions.

The GUI 200 may also provide a 17 years & younger profile upload interface region 215. Due to privacy concerns about minors using social media sites and consequent legislation and regulations, website and application privacy policies, the disclosed application may provide the 17 years & younger profile upload interaction region 215 to allow those 17 and younger to access the application with a profile uploaded in accordance with application privacy and data security policies and guidelines. The 17 years & younger profile upload interaction region 215 may allow a user 17 and younger to upload profiles with limited information, limited communication and interaction with other users and restrictions to certain content hosted by the application. Restrictions might include disabling access to the musician social & dating interface 210 or restrict access to certain media hosted by the application which may be mature in content or inappropriate or illegal for users 17 and younger from viewing or hearing. The 17 years & younger profile upload interaction region 215 may provide functionality to require a user, when accessing 17 years & younger profile upload interaction region 215 to verify age and identity or require parental permission to upload a profile to the 17 years & younger profile upload interaction region 215.

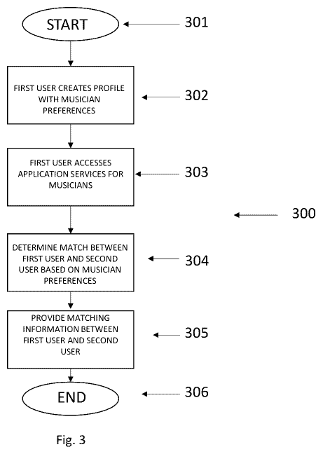

FIG. 3 illustrates acts in a method of connecting musicians with one another on a communications network 200 in a musician social network application, in accordance with the GUI 200 and the disclosed functionality in FIG. 1 and FIG. 2. In act 301, a first user, such as a first musician, accesses the communication network 100 established for the first user to use the musician social network application. The musician social network application may request a login with an existing account, set up a new account or may allow the user to enter more conveniently through an existing social media platform account and login.

In an act 302 according to the disclosure, the first user may create a profile on the musician social network application. For the profile, the first user may provide personal information such as age, location, birthday and/or employment, among other types of personal information. The first user may provide musician preference information to the application. The first user may provide musician preference information to the application via the communication network via a UE such as a mobile device or a desktop device The musician preference information may include at least one of the following: musical genre, musical style, past musical performance, location of the user, musical instrument preference and preferred scheduling. The first user may populate the profile with a profile photo, links to past performances, upcoming performances, band or orchestra membership. The first user may provide teaching credentials and information, if the first user wishes to offer teaching instruction. In that case, the first user may create or access a teacher profile provided by the musician social network application. The first user may also upload selfie videos, clips, audio samples or other self-generated media for upload and display through the profile(s). The first user may be interested in dating and social interaction and may enter that information in the profile or access a musician dating and social service provided by the application. In the musician dating and social services, the first user may upload dating and social information, such as their own personal information and preferences, and what they are looking for through the musician dating and social services. If the first user is age 17 or younger, the first user may upload a 17 and younger profile to allow access to minors, but compliant with the application/websites privacy policies and local or federal regulations and statutes. In an aspect, the first user may login to the application through credentials from a social media site, to allow a fast and secure login. In aspect, the first user may upload a free profile through the free profile uploads interface region 212 of the GUI 200 of the application.

In act 303, the musician social network application may allow the first user, once he/she is logged in, to access services provided by the musician social network application. For example, the first user may view access the skill level interface region 204 to access one of the provided skill level services. A first user may interact with and access professionals only, intermediate players or beginner player services, depending on the first user's skill level or access to a particular skill level service. The first user may interact with and access the personal equipment for sale interface region 206 or the musical equipment for purchase interface region 207, to view and interact with content provided by a second user who has personal equipment for sale or musical equipment for purchase. The first user may view or interact with a second user's selfies through the selfie video section interface region 208. The first user may access the musician dating and social interface region 210 to view, use and interact with second users who are looking for dating or social interaction with other musicians. The first user may view vendor pop-up advertisements, filter or select vendor pop-up advertisement content through the vendor advertisement pop-ups interface region 211. The first user may view available public or private profiles available through the application via the private profile available interface region 213 or the public profiles available interface region 214.

In act 304, the musician social network application may match the first user with the second user based on the first user's preferences and profile information and the second user's preferences and profile information. The first user may desire similar or related second users, such as other musicians with similar musical preference information. In an aspect, the musician profile information and/or the musician preference information may be stored in a record on the UE used by the first user, stored on a server 107 or stored on a database 108. The database 108 may store the musician profile information and/or the musician preference information in a distributed database system. The database 108 storing the musician profile information and/or the musician preference information may be connected directly or may be external to the UE or server.

The musician social network application, in an aspect, may determine a match between first user with the second user in the musician dating and social services via interaction with the musician dating and social interface region. The application may use a matching algorithm customized for matching the musician profile information and/or the musician preference information through musician preferences, interests, musical styles, region, availability, type of relationship desired, past musician dating and social experiences and other factors that the first user may supply in the profile or express as a preference in the musician dating and social services of the application.

The musician social network application, in an aspect, may match up the first user with a second user through the teacher profile information services, if the first user is looking for musical instruction. A music teacher may be matched with prospective students as well.

In an aspect, the musician social network application may match up the first user with a second user through the skill set services using the skill set interface region 204 of the GUI 200. For example, a first user may be a professional, in which case the application may match the first user with a second user who is also a professional, along with factoring other musician profile information and/or musician preference information and style information.

In an aspect, the musician social network application may match buyers and sellers of personal equipment or musical equipment through the personal equipment for sales services and the musical equipment for purchase services, via the GUI 200 for the respective service interface regions.

In an aspect of the disclosure, the musician social network application may determine a match between the first user and the second user using the musician profile information and/or the musician preference information, which may include determining a nearest match based on the musician profile information and/or the musician preference information, where the nearest match is based on a scoring metric or measure indicating how similar or “near” in graph space that a second user is to the first user in terms of musician preference information. In another aspect, the musician social network application may process the musician profile information and/or the musician preference information using a Bayesian estimator algorithm, statistical regression algorithm, neural network, machine learning model or other process for matching the first user with the second user based on the musician preference information. In an aspect of the disclosure, the musician social network application may determine the nearest match by determining a list of potential matches, such as a list of individuals or a group of musicians such as a band or orchestra, for example.

In an aspect of the disclosure, the application may select the second user based on a recent time period of a second user performance. For example, if the second user has recently played according to the musician preference information in the past year, this information may weigh heavily in determining the second user, as opposed to if the second user has not played in several years.

In a further aspect of the disclosure, the musician social network application may select the second user based on a substitution for the musician preference information. For example, if a suitable second user is not available that matches a desired “closeness” of fit for the first user's musician profile information and/or musician preference information, an alternative set of musician profile information and/or musician preference information may be used to select the second user, such as by substituting similar styles or genres based on a model or graph of musician preference information.

In act 305, the musician social network application provides the matched information between the first user and the second user for the services described in FIG. 2 and herein. The musician social network application may provide a list of matching users, links to matching user profile, open a messaging service between the first and second user, send an email, text or chat link to the first user and/or the second user or display a matching profile with profile photo and general profile information for the first and second user. The first user and the second user may subsequently interact with each other to meet up for a social interaction, a date, video chats, visit a virtual sales platform for matching sales and purchases, conduct online or in-person instruction between a music teacher and a student and other similar interactions related to the services provided by the application and disclosed herein.

The sequence diagram in FIG. 3 may be encoded in a signal bearing medium, a computer readable medium such as a memory, programmed within a device such as one or more integrated circuits, or processed by a controller or a computer. If the methods are performed by software, the software may reside in a memory resident to or interfaced to the any type of non-volatile or volatile memory interfaced or resident to the memory incorporated in the components in the communications network 100. Such memory may include an ordered listing of executable instructions for implementing logical functions. A logical function may be implemented through digital circuitry, through source code, through analog circuitry, or through an analog source such through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method of connecting musicians on a communications network, the method comprising:
accessing a musician social network application by a first user through the communications network;
providing first musician profile information and/or first musician preference information to the social network application by the first user;
processing, by the musician social network application, the first musician profile information and/or the first musician preference information to determine a potential match with a second user, based on second musician preference information and/or second musician profile information about the second user; and
transmitting the second musician preference information and/or the second musician profile information to the first user.

2. The method of claim 1, where providing the first musician profile information comprises providing information about first user personal information, a first user profile photo, social media membership information, musical genre, musical skill level, musical style, past musical performance, a location of the user, musical instrument preference, preferred scheduling or a combination thereof.

3. The method of claim 1, where providing the first musician preference information comprises providing social interaction preference information, social dating preference information, musical equipment purchase/sale information, musician collaboration information or a combination thereof.

4. The method of claim 1, where providing the first musician profile information comprises providing privacy access information to determine a level of access by other users to the first musician profile information.

5. The method of claim 1, where accessing the musician social network application comprises accessing a plurality of musician social network services to determine the potential match with the second user.

6. The method of claim 5, where accessing the plurality of musician social network services comprises accessing personal equipment for sale services, musical equipment for sale services, musician dating and social services, vendor advertisement pop-up ads services, music teaching services, musician skill level networking services or a combination thereof.

7. The method of claim 1, where processing the first musician profile information and/or the first musician preference information comprises determining a nearest match based on the first musician profile information and/or the first musician preference information and the second musician preference information and/or the second musician profile information about the second user.

8. The method of claim 1, where transmitting the information about the second user to the first user comprises transmitting an SMS message, an email, a link to a social media page of the second user, a voice message or a combination thereof.

9. The method of claim 1, where accessing the musician social network application by the first user comprises accessing the musician social network application with credentials from a different social network platform.

10. An apparatus for connecting musicians on a communications network, the apparatus comprising at least one processor and at least one memory storing computer program code, the at least one memory and the computer program code configured to, with the processor, cause the apparatus to at least:
access a musician social network application by a first user through the communications network;
provide first musician profile information and/or first musician preference information to the social network application by the first user;
process, by the musician social network application, the first musician profile information and/or the first musician preference information to determine a potential match with a second user,
based on second musician preference information and/or second musician profile information about the second user; and
transmit the second musician preference information and/or the second musician profile information to the first user.

11. The apparatus of claim 10, where the instructions to provide the first musician profile information comprise instructions to provide information about first user personal information, a first user profile photo, social media membership information, musical genre, musical skill level, musical style, past musical performance, a location of the user, musical instrument preference, preferred scheduling or a combination thereof.

12. The apparatus of claim 10, where the instructions to provide the first musician preference information comprises instructions to provide social interaction preference information, social dating preference information, musical equipment purchase/sale information, musician collaboration information or a combination thereof.

13. The apparatus of claim 10, where the instructions to provide the first musician profile information comprise instructions to provide privacy access information to determine a level of access by other users to the first musician profile information.

14. The apparatus of claim 10, where the instructions to access the musician social network application comprise instructions to access a plurality of musician social network services to determine the potential match with the second user.

15. The apparatus of claim 10, where the instructions to access the plurality of musician social network services comprise instructions to access personal equipment for sale services, musical equipment for sale services, musician dating and social services, vendor advertisement pop-up ads services, music teaching services, musician skill level networking services or a combination thereof.

16. A user interface for connecting musicians on a communications network, the user interface comprising a plurality of input/output interface regions arranged on a user device display, the plurality of input/output interface regions comprising:
a plurality of musician profile interface regions for providing musician profile and/or musician preference information;
a plurality of market exchange interface regions for musicians to engage in sales and/or purchase of musical equipment; and
a plurality of musical social network interaction interface regions for a first user to interact with other users in social network services.

17. The user interface of claim 16, where the plurality of musician profile interface regions comprises a general profile information interface region, a profile picture interface region, a teacher profile information interface region, a profile photo interface region, a selfie video interface region, a sign-in from social media page interface region, a 17 years and younger profile upload interface region or a combination thereof.

18. The user interface of claim 16, where the plurality of market exchange interface regions comprises a personal equipment for sale interface region, a musical equipment for purchase interface region or a combination thereof.

19. The user interface of claim 16, where the plurality of musical social network interaction interface regions comprises a skill level interface region, an upload to video site interface region, a musician dating & social interface region, a vendor advertisement pop-ups page interface region, a free profile uploads interface region, a private profile available interface region or a combination thereof.

20. The user interface of claim 16, the plurality of musical social network interaction interface regions provides access restrictions related to one or more of the plurality of musical social network interaction interface regions.
